(19) United States
(12) Patent Application Publication
(10) Pub. No.: US 2024/0308529 A1
(43) Pub. Date: Sep. 19, 2024

(54) METHOD FOR OPTIMISING THE DYNAMIC CONTROL OF A VEHICLE CHASSIS

(71) Applicants: AMPERE S.A.S., Boulogne Billancourt (FR); NISSAN MOTOR CO., LTD., Kanagawa-ku Kanagawa (JP)

(72) Inventors: Rodolphe GELIN, Guyancourt Cedex (FR); Thierry GIACCONE, Guyancourt Cedex (FR); Xavier MOUTON, Guyancourt Cedex (FR)

(73) Assignee: AMPERE S.A.S., Boulogne Billancourt (FR)

(21) Appl. No.: 18/573,761

(22) PCT Filed: Jun. 27, 2022
(86) PCT No.: PCT/EP2022/067513

§ 371 Date: Dec. 22, 2023

(30) Foreign Application Priority Data
Jun. 25, 2021 (FR) FR2106808

(51) Int. Cl. B60W 40/068; B60W 50/00; B60W 50/06

(52) U.S. Cl. CPC B60W 40/068; B60W 50/06; B60W 2050/0083; B60W 2420/403; B60W 2552/40; B60W 2555/20; B60W 2556/40

(57) ABSTRACT

A method is for determining the vehicle-extrinsic component of the slip rate of a stretch of road located in front of a motor vehicle moving towards the stretch of road. The method includes acquiring data relating to the condition of the stretch of road, and subsequently determining a value of the vehicle-extrinsic component of the slip rate of the stretch of road by a machine-learning algorithm applied to the acquired data relating to the condition of the stretch of road.

### TECHNICAL FIELD

The present invention relates to a method for optimizing dynamic control of the chassis of a motor vehicle.

It in particular relates to a method for optimizing dynamic control of a chassis based on anticipation of the coefficient of friction of the vehicle on the road over which it is about to drive.

### PRIOR ART

The appearance of embedded electronics applications has allowed active safety systems to be developed to complement high-performance passive systems.

Originally, these active safety systems were intended to assist the driver of the vehicle in particularly dangerous situations, before becoming driver assistance systems allowing improved driver comfort, increased energy efficiency, etc.

Autonomous driver assistance systems, for which the vehicle must be capable of handling critical situations on its own, have also appeared.

Dynamic chassis control therefore consists in controlling the chassis and engine/motor systems of a vehicle at all times so as to be able to meet the needs of the driver, whether the latter is human or autonomous.

Thus, dynamic control of the chassis must take into account the states and performance levels of the systems, as well as the environment of the vehicle. This environment of the vehicle designates both the state of the road and ambient weather conditions.

Specifically, the commands sent to the chassis and engine/motor systems, for example when entering a corner, may not be the same on a slippery road as on a road that is not slippery. For example, electronic stability control (ESC) intervenes when a low-grip road is being driven on, to complement the driver's action on the steering wheel.

An essential datum to check for these systems is the coefficient of friction of the vehicle. It is known to measure in real time the coefficient of friction of each wheel, called the tire-road coefficient of friction, by calculating the ratio between the vertical force and the longitudinal force at each wheel.

Currently, calculation of this coefficient of friction makes it possible, through observation of its linearity, to determine whether the tire is operating in a linear and efficacious operating range.

It is known to calculate the coefficient of friction applicable to the vehicle in a “reactive” manner, i.e. the calculated coefficient of friction is already applicable or is in the process of becoming applicable to the vehicle. It is therefore not possible using current methods to anticipate the coefficient of friction in order to configure the chassis and engine/motor parameters before this coefficient of friction is applied to the vehicle.

In addition, the coefficient of friction is not shareable information common to all the vehicles, this coefficient of friction depending on mechanical performance parameters of the vehicle in question.

There is therefore a need to define a tool common to all vehicles allowing for each thereof their coefficient of friction to be anticipated, so as to improve dynamic control of the chassis thereof so as to make it more efficacious in all circumstances.

### SUMMARY OF THE INVENTION

One subject of the invention is therefore a method for training an algorithm for automatically estimating the component extrinsic to the vehicle of the coefficient of friction of a road segment that matches, to state data relating to the road segment provided by way of input, an output value of the component extrinsic to the vehicle of the coefficient of friction of the road segment, training the estimating algorithm comprising a phase of learning from a database of data on the state of road segments associated with values of components extrinsic to the vehicle of the coefficient of friction of these road segments, the collected data on the state of the road segments being collected by one or more vehicles equipped with a camera oriented toward the front of the vehicle.

Advantageously, the data on the state of road segments comprise images of the road segment captured by a camera placed at the front of the vehicle and information on the weather and temperature at the time of capture of the image.

Advantageously, the component extrinsic to the vehicle of the coefficient of friction associated with the data on the state of the road segments is deduced from the coefficient of friction associated with the road segments, the coefficient of friction being measured by the vehicle capturing the state data or being known prior to the collection of the state data by the vehicle.

Advantageously, the component extrinsic to the vehicle of the coefficient of friction associated with the data on the state of the road segments is deduced from the coefficient of friction associated with the road segments and from a component intrinsic to the vehicle of the coefficient of friction, the coefficient of friction being measured by the vehicle capturing the state data, by way of measurement of the vertical force on the one hand and of the longitudinal force on the other hand exerted by the vehicle on the wheel at the point of contact with the ground, or being known prior to collection of state data by the vehicle, the component intrinsic to the vehicle of the coefficient of friction being specific to the vehicle capturing the state data.

In another embodiment, the value of the component extrinsic to the vehicle of the coefficient of friction associated with the data on the state of the road segments is quantified by a user of the vehicle during collection of the data on the state of the road segments.

Another subject of the invention is a method for determining the component extrinsic to the vehicle of the coefficient of friction of a road segment located in front of a motor vehicle moving toward said road segment, characterized in that it comprises the following steps:
acquiring at least one state datum relating to the road segment,
determining a value of the component extrinsic to the vehicle of the coefficient of friction of said road segment by means of an algorithm for automatically estimating the component extrinsic to the vehicle of the coefficient of friction of a road segment trained according to the preceding method.

The present invention is therefore based on decomposition of the coefficient of friction of the vehicle into, on the one hand, a component extrinsic to the vehicle of the coefficient of friction and, on the other hand, a component intrinsic to the vehicle of the coefficient of friction. The component extrinsic to the vehicle is based on environmental parameters that are therefore independent of the vehicle. It is therefore shareable and common to all vehicles. In contrast, the component intrinsic to the vehicle is based on parameters specific to the vehicle, and is therefore unique to each vehicle.

Thus, the component extrinsic to the vehicle of the coefficient of friction is determined before the vehicle passes over the road segment with which it is associated. The extrinsic component is common to any vehicle, which may use it with its own performance parameters to determine the coefficient of friction in an anticipatory way, before passing over the road, and no longer reactively, by live measurement.

Advantageously, the at least one state datum relating to the road segment comprises one or more images of the road segment captured by a camera placed at the front of the vehicle.

Specifically, the component extrinsic to the vehicle of the coefficient of friction is dependent on the state of the road.

Preferably, the at least one state datum of the road segment comprises one or more pieces of weather and temperature information.

Specifically, the component extrinsic to the vehicle of the coefficient of friction is dependent on the weather conditions.

Advantageously, the method comprises, following the step of determining the value of the component extrinsic to the vehicle of the coefficient of friction, a step of generating and updating a map of vehicle-road grip quality.

The map makes it possible to store, for a given road segment, various values of the component extrinsic to the vehicle of the coefficient of friction for various given weather and temperature conditions. It allows the vehicle to access an extrinsic-component value without having to repeat the steps of acquiring state data and of determining the value. As a result, real-time constraints on the estimating algorithm may be relaxed, or indeed time and system resources saved and efficacy improved.

Preferably, the step of generating and updating a road grip-quality map comprises steps of:
averaging the component extrinsic to the vehicle of the coefficient of friction calculated in the determining step with values of components extrinsic to the vehicle of the coefficient of friction already stored in the map for the same road segment and similar weather and temperature data,
storing the averaged value in association with the road segment and the current meteorological data.

Thus, the extrinsic-component values stored in the map are refined and the accuracy of the map is more robust.

Advantageously, storage is performed locally and/or on a shared server.

The shared server allows a vehicle other than the one that carried out the step of determining the component extrinsic to the vehicle of the coefficient of friction to obtain this value.

Advantageously, the method comprises assigning a confidence score associated with the value stored in the map, the confidence score being calculated using a statistical algorithm.

Another subject of the invention is a method for optimizing dynamic control of the chassis of a vehicle on the basis of a component extrinsic to the vehicle of the coefficient of friction obtained using a method as defined above, this method comprising the following steps:
retrieving a value of the component extrinsic to the vehicle of the coefficient of friction associated with a road segment in front of the vehicle,
determining a prediction of the value of the coefficient of friction associated with said road segment on the basis of the retrieved component extrinsic to the vehicle of the coefficient of friction,
configuring the parameters of the chassis of the vehicle depending on the prediction.

Thus, the vehicle anticipates, on the basis of a value of the component extrinsic to the vehicle of the coefficient of friction, the value of the coefficient of friction on the road segment over which the vehicle is about to be driven. Thus, its chassis parameters may be modified upstream of the road segment in order to be optimal when the road segment is reached, and not reactively after measurements taken while driving over this road segment, this resulting in a loss of efficacy, especially when an area with a low extrinsic component is being approached.

Preferably, the value of the component extrinsic to the vehicle of the coefficient of friction retrieved in the retrieving step is the value calculated in the step of determining a value of the component extrinsic to the vehicle of the coefficient of friction, the vehicle the chassis of which is modified being the same as the one that performed this step.

Thus, the vehicle uses the value of the extrinsic component of the coefficient of friction that it has just calculated without consulting the map. It determines the value for itself and uses it in real time. The vehicle is therefore autonomous in respect of optimization of its chassis parameters in an anticipatory manner before the corresponding road segment is driven over, while also optimizing use of memory resources on board the vehicle, in particular because the cache corresponding to the route to be traveled is not used since the vehicle then does not store any map on-board.

Alternatively, the value of the component extrinsic to the vehicle of the coefficient of friction is retrieved from the generated road grip-quality map.

Thus, the vehicle may be a vehicle different from the one that carried out the steps of acquiring state data, and of determining and storing in the map the value of the component extrinsic to the vehicle of the coefficient of friction. Thus, the vehicle that retrieves the value from the map may not have the tools required for these steps, such as a camera or an on-board computer powerful enough to carry out machine-learning methods and procedures.

Preferably, the component extrinsic to the vehicle of the coefficient of friction is retrieved from the road grip-quality map depending on geolocation data and meteorological data.

Advantageously, the prediction of the value of the coefficient of friction associated with the road segment is dependent on the retrieved value of the component extrinsic to the vehicle of the coefficient of friction and on a component intrinsic to the vehicle of the coefficient of friction, this intrinsic contribution being specific to the vehicle.

Preferably, the component intrinsic to the vehicle of the coefficient of friction is dependent on a wear factor of the chassis of the vehicle, and on a factor representative of the potential of the chassis of the new vehicle. In particular, the tires—characteristics of which such as the type of tire (width, height, type of rubber, etc.), their wear, their inflation pressure and their temperature affect the component intrinsic to the vehicle of the coefficient of friction—form part of the chassis.

Advantageously, the prediction of the value of the coefficient of friction associated with the road segment is determined on board the vehicle.

Preferably, the prediction of the value of the coefficient of friction associated with the road segment is determined in real time.

Another subject of the invention is a motor vehicle able to implement the method for optimizing dynamic control of the chassis described above.

### BRIEF DESCRIPTION OF THE DRAWINGS

Other aims, features and advantages of the invention will become apparent on reading the following description, which is given merely by way of non-limiting example, with reference to the appended drawings, in which:

FIG. 1 illustrates the steps of a method for determining the component extrinsic to the vehicle of the coefficient of friction associated with a road segment;

FIG. 2 illustrates the sub-steps of the step of generating a grip-quality map of the method of FIG. 1;

FIG. 3 illustrates the steps of a method for optimizing dynamic control of the chassis of a vehicle according to the invention;

FIG. 4 shows a first embodiment of the invention;

FIG. 5 shows a second embodiment of the invention; and

FIG. 6 shows a third embodiment of the invention.

### DETAILED DESCRIPTION OF AT LEAST ONE EMBODIMENT

The principle of the invention is to decompose the coefficient of friction of the vehicle, which datum is known and denoted μ, into a component μₑₓₜ extrinsic to the vehicle of the coefficient of friction, and a component μᵢₙₜ intrinsic to the vehicle of the coefficient of friction.

The component μₑₓₜ extrinsic to the vehicle of the coefficient of friction corresponds to the grip quality of the road, i.e. to the influence of factors external to the vehicle on the coefficient of friction μ of the vehicle. The extrinsic component μₑₓₜ is the product of two factors relating to the state of the road and to weather and temperature conditions, respectively. The extrinsic component μₑₓₜ is therefore completely independent of the vehicle, and is the same for all vehicles traveling along the same road at the same time, or at least under similar environmental conditions.

The component μᵢₙₜ intrinsic to the vehicle of the coefficient of friction corresponds to the influence of the technical characteristics of the vehicle itself on the coefficient of friction μ. It is therefore the product of two factors, on the one hand a wear factor of the chassis and on the other hand a potential factor of the chassis of the new vehicle, which is related to the characteristics of the chassis of the vehicle when it leaves the factory with new tires. The component μᵢₙₜ intrinsic to the vehicle is therefore specific to each vehicle.

The coefficient of friction μ is the product of the two components μₑₓₜ and μᵢₙₜ extrinsic and intrinsic to the vehicle of the coefficient of friction:

$$μ = {μ}_{i n t} \times {μ}_{e x t}$$

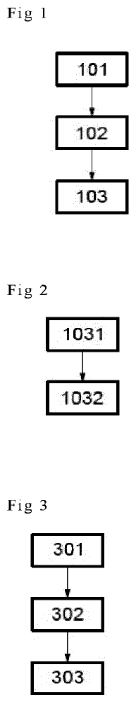

FIG. 1 shows the steps of a method for determining the component μₑₓₜ extrinsic to the vehicle of the coefficient of friction associated with a road segment. This method is carried out by a vehicle preparing to drive over the road segment.

This method for determining the component μₑₓₜ extrinsic to the vehicle of the coefficient of friction associated with a road segment is based on an estimator formed by an estimating algorithm, that matches, to input state data of a road segment, an output value of the component μₑₓₜ extrinsic to the vehicle of the coefficient of friction for the road segment. These state data may include an image of the road segment and weather and temperature information.

This estimating algorithm is an algorithm using machine-learning techniques, i.e. it requires, before becoming operational, a learning phase in which the algorithm will take on board large amounts of information in order to “learn” how to determine an extrinsic component μₑₓₜ from any road-segment state data input.

The learning phase, or training phase, of the automatic estimating algorithm is therefore carried out before the system is deployed to individual end users, i.e. before a method for determining the component μₑₓₜ extrinsic to the vehicle of the coefficient of friction associated with a road segment as illustrated in FIG. 1 is implemented, or in other words before commercialization.

The learning phase may be carried out in a first way by collecting images of road segments and meteorological and temperature data at the time of image collection, and relating these to the measurement of the actual coefficient of friction μ on these road segments.

The actual coefficient of friction μ is measured by way of measurement on the one hand of the vertical force Fz applied by the vehicle to the wheel at the point of contact with the ground, and on the other hand of the longitudinal force Fx applied by the vehicle to the wheel at the point of contact with the ground. The measurement is carried out using sensors fitted to the one or more vehicles carrying out the collection of the learning phase.

The vertical force Fz is also known as the weight at each wheel, and may be deduced from the weight of the vehicle carrying out the learning phase and the weight transferred to each wheel.

The longitudinal force Fx may be deduced from the braking and acceleration torques exerted by the chassis or the drive train.

The actual coefficient of friction μ is obtained from the ratio between Fx and Fz.

The learning phase may also be carried out by collecting images of road segments the coefficient of friction μ of which is known in advance, for example on test circuits, or by collecting images of road segments for which experienced drivers have given their opinion as to the grip quality of the road, the collected images being associated with weather and temperature data. This learning phase may be carried out by a fleet of a plurality of vehicles equipped with sensors allowing the coefficient of friction μ to be measured and the performance of which on leaving the factory and the respective wear of which are known, or by a single one of these vehicles.

Generally, knowledge of the vehicle used or of the vehicles used to perform the learning phase implies knowledge of the component μᵢₙₜ intrinsic to the vehicle of the coefficient of friction of these vehicles. Specifically, by virtue of knowledge of the technical characteristics of the vehicles, such as their wear at the time of the learning phase (tire, elasticity, damping, kinematics) and their performance on leaving the factory, the component μᵢₙₜ intrinsic to the vehicle of the coefficient of friction may be deduced.

It is therefore possible, based on knowledge of the intrinsic component μᵢₙₜ and of the actual coefficient of friction μ, to deduce by division the component μₑₓₜ extrinsic to the vehicle of the coefficient of friction in the first two cases:

$${μ}_{ext} = \frac{μ}{{μ}_{i n t}}$$

It is also possible to deduce from the opinions of experienced drivers a value quantifying the extrinsic component μₑₓₜ.

Once collected, all of these road-segment image data associated with a value of the component μₑₓₜ extrinsic to the vehicle of the coefficient of friction of said road segments and with meteorological and temperature data are learned by the estimating algorithm. The learning phase therefore comprises constructing a database of data on states of road segments associated with values of components extrinsic to the vehicle of the coefficient of friction of these road segments. An LSTM RNN (LSTM standing for Long Short-Term Memory and RNN standing for Recurrent Neural Network) or indeed GRU (GRU standing for Gated Recurrent Unit) neural network is then trained using the database of collected data on the state of road segments associated with the values of the components μₑₓₜ extrinsic to the vehicle of the coefficient of friction.

The estimator is capable, once it has taken on board a certain amount of information, of being accurate enough to return as output a reliable value of the extrinsic component μₑₓₜ corresponding to state data given as input. These state data are an image of a road segment and weather and temperature conditions at the time of capture of the image. Once the learning phase has ended, the estimator is therefore functional and may be placed on board a vehicle. The determining method according to FIG. 1 may thus be implemented.

In another embodiment, the estimator is capable during the learning phase of also learning how to determine weather data from images of road segments. Thus, the functional estimator, once the learning phase has ended, is capable of returning as output a reliable value of the extrinsic component μₑₓₜ corresponding to state data given as input comprising only one or more images of a road segment.

Therefore, the estimator no longer needs the weather conditions as input. Nevertheless, this embodiment is less accurate, because the state data supplied by way of input for the estimator are thus less complete.

The following describes the steps of the method of FIG. 1, which is a method for determining the component μₑₓₜ extrinsic to the vehicle of the coefficient of friction associated with a road segment.

In step 101, the vehicle acquires state data relating to the road segment. This is done by means of a camera oriented toward the front of the vehicle and the objective lens of which is directed onto the road segment on which the vehicle is about to drive. The camera may for example be the camera of an ADAS (ADAS standing for Advanced Driver Assistance System), or another camera. Weather and temperature information such as atmospheric pressure, humidity, rainfall, measurement of black ice, of snow, or any other useful data are also acquired, for example by on-board sensors, or from a server external to the vehicle such as an internet site.

The length of the road segment varies, because it depends on the frequency at which images are sent to the estimator, this frequency being variable and adjustable depending on the desired precision and also on the resolution of the camera used, which may for example allow a sufficient quality to be obtained over a length of road of one hundred meters. The higher the frequency at which images are sent to the estimator, the more it will be possible to decrease the considered length of the road segment.

In step 102, the vehicle determines the value, denoted X, of the component μₑₓₜ extrinsic to the vehicle of the coefficient of friction associated with the road segment on the basis of the state data acquired in step 101. To do this, the state data are sent as input to the estimator of the component extrinsic to the vehicle of the coefficient of friction located on board the vehicle. This estimator matches, to the input state data, an output value of the component μₑₓₜ extrinsic to the vehicle of the coefficient of friction for the road segment.

In step 103, a road-segment grip-quality map is generated and/or updated. The sub-steps of this generation and update of the grip-quality map are illustrated in FIG. 2.

In step 1031, the value X of the component extrinsic to the vehicle of the coefficient of friction determined in step 102 is weighted with extrinsic-component values calculated previously for similar weather conditions on the same road segment and the average of which is stored in the map. For example, denoting the value stored in the map Yₙ, Yₙ being equal to the average of the n extrinsic-component values calculated previously for said road segment and similar meteorological conditions, the new averaged value, denoted Yₙ₊₁, may be assigned the value:

$${Y}_{n + 1} = \frac{( {Y}_{n} \times n ) + X}{n + 1}$$

The new average value Yₙ₊₁ determined in this step 1031 may also be calculated using any formula weighting the weight of the value X determined in step 102 with the weight n of the number of previous values that allowed Yₙ to be determined. This average value could in other embodiments be determined with exclusion from the n previously calculated values used to determine Yₙ of values far from the average, or with the standard deviation or variance of these values for said road segment and similar weather conditions taken into account.

If no previous value has been calculated for the geolocation data of the road segment under the weather and temperature conditions of the acquisition, i.e. if n has a value of zero, the averaged value takes the value X of the component extrinsic to the vehicle determined in step 102. As a variant, the averaged value may also take the value of an average of data stored in the map for different but similar meteorological conditions. For example, if the map associated with the geolocation data of the road segment does not contain a value for a temperature of 0° C. under snow, but it contains two values for two temperatures of −5° C. and 5° C. under snow, respectively, the averaged value for 0° C. may be the average of these two values.

Any other smoothing or averaging algorithm may be used to increase the robustness of the map.

The classes of weather conditions making up the map for a road segment may for example include a class for dry weather, a class for fog, a class for light rain (<2 mm/h), a class for moderate rain (between 2-7 and 6 mm/h), a class for heavy rain (>7.6 mm/h), a class for snow and a class for ice.

The classes of temperature data making up the map for a road segment may for example include a class for a temperature below −16° C., a class for a temperature between −16° C. and −12° C., a class for a temperature between −12° C. and −10° C., a class for a temperature between −10° C. and −6° C., a class for a temperature between −6° C. and −4° C., a class for a temperature between −4° C. and 0° C., a class for a temperature between 0° C. and 5° C., a class for a temperature between 5° C. and 10° C., a class for a temperature between 10° C. and 20° C., a class for a temperature between 20° C. and 30° C., a class for a temperature between 30° C. and 40° C., a class for a temperature between 40° C. and 50° C., and a class for a temperature above 50° C.

Thus, with these classes, for a road segment the map should in the long term contain, for each temperature value and for each type of weather, a value of the component μₑₓₜ extrinsic to the vehicle of the coefficient of friction associated with the road segment.

In step 1032, the averaged value Yₙ₊₁ determined in step 1031 is stored in association with the geolocation data of the road segment and the weather and temperature conditions during the acquisition of the state data in step 101. Thus, the values stored in the map get more accurate and robust as vehicles performing the steps of the method of FIG. 1 are driven over the road segment. Since the components extrinsic to the vehicle of the coefficient of friction are independent of the vehicle by definition, it is possible to store an average of these extrinsic components while still meeting the constraints of the GDPR (GDPR standing for General Data Protection Regulation).

The map will therefore be completed over time by associating, with each given road, a table of values of the component μₑₓₜ extrinsic to the vehicle of the coefficient of friction as a function of meteorological and temperature conditions.

The map may be generated on a server shared between a set of vehicles capable of feeding it with data on components μₑₓₜ extrinsic to the vehicle of the coefficient of friction. In the case of a shared map, its construction is much faster, and the values are more accurate, the amount of information logically being much larger. The shared map is therefore more robust.

The map may also be generated locally, i.e. on board the vehicle. It is then constructed entirely by this vehicle and accessible only by it.

A given vehicle having access to a shared map may, in addition, construct a local map. This for example allows the method for optimizing dynamic control of the chassis to be implemented, even if there is a problem connecting to the shared map, or quite simply in order for communications with the shared map to be limited, and thus the resources of the vehicle to be saved.

In the case where a vehicle having access to the shared map in addition creates a local map, it may simply store a portion of the shared map on board. It is thus able to obtain, as required, a complete local map that is identical to the information that it would have obtained through communication with the shared map, without the need to renew the connection.

A confidence score may also be associated in the local or shared map with each stored averaged value of the component μₑₓₜ extrinsic to the vehicle of the coefficient of friction.

This confidence score, which is obtained using a statistical algorithm applied to some or all of the parameters that allowed the map to be constructed, describes an indication of the accuracy of the stored value. For example, the confidence score may depend on the standard deviation of values determined under the same conditions, or simply on the number of these previously determined values, noted n above.

FIG. 3 shows the steps of a method for optimizing dynamic control of a vehicle on the basis of a component μₑₓₜ extrinsic to the vehicle of the coefficient of friction.

In step 301, the vehicle retrieves a value of the component μₑₓₜ extrinsic to the vehicle of the coefficient of friction associated with the road segment ahead of the vehicle.

The retrieved value of the component μₑₓₜ extrinsic to the vehicle of the coefficient of friction may be either the value stored in the, shared and/or local, map associated with the location data of the road segment and with the weather and temperature conditions present at the time of step 301, or the value determined in step 102.

The retrieved value is the value determined in step 102 when the method of FIG. 3 is carried out by the same vehicle as the one that carried out the method for determining the extrinsic component of FIG. 1, and when the two methods of FIGS. 1 and 3 are carried out in real time and during the same trip over the road segment. Thus, only vehicles equipped with tools allowing the method of FIG. 1 to be carried out are able to retrieve this value, these tools in particular comprising a front camera placed so as to capture images of the road over which the vehicle is about to drive over forwards, an on-board computer able to implement the estimator and rain sensors or any other means allowing weather, temperature and geolocation information to be obtained.

The retrieved value is in contrast the value stored in the map when the method of FIG. 3 is carried out either by a vehicle other than the one that carried out the determining method of FIG. 1, this vehicle retrieving the value from the shared map, or by the same vehicle as the one that carried out the determining method of FIG. 1, but that carried it out during a previous trip, and that has thus constructed a local map. The vehicle carrying out the method of FIG. 3 retrieves, as it passes over a road segment, the value of the component extrinsic to the vehicle of the coefficient of friction stored in the map for the geolocation data of this road segment and for the current weather and temperatures conditions.

In step 302, the vehicle determines a prediction of the value of the coefficient of friction μ associated with the road segment for which it has just retrieved a component μₑₓₜ extrinsic to the vehicle of the coefficient of friction. To do this, it determines its own component μᵢₙₜ intrinsic to the vehicle of the coefficient of friction, via the product defined above of the wear factor of the chassis of the vehicle and of the potential factor of the chassis of the new vehicle. This prediction is made on board the vehicle intended to optimize its chassis parameters, and in real time, just before it passes over the road segment in question. With a view to saving resources, it is also possible for the prediction to be made at the beginning of the route and then stored on board. The latter case requires a local map, optionally accompanied by access to the shared map, the local map containing the extrinsic-component values of the entire future route.

In step 303, the vehicle configures its chassis parameters depending on the prediction of step 302, so as to optimize its performance when driving over the road segment.

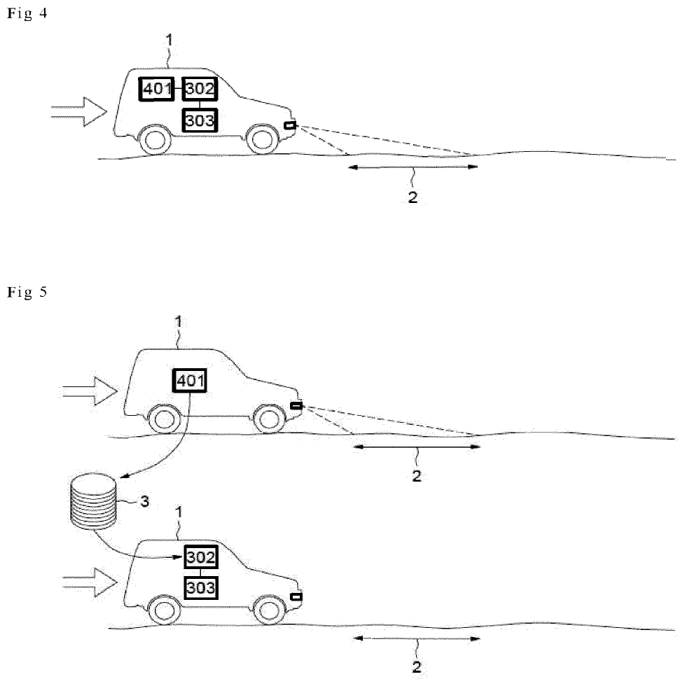

FIG. 4 shows a first embodiment of the invention.

A vehicle 1 is driving toward a road segment 2, over which it has never driven before. It has therefore not been able to measure the coefficient of friction μ associated with this road segment 2.

The vehicle 1 is equipped with tools making it possible to carry out the method illustrated in FIG. 1 for determining a component μₑₓₜ extrinsic to the vehicle of the coefficient of friction associated with a road segment. These tools are in particular a front camera placed so as to capture images of the road over which the vehicle is about to be driven forward, an on-board computer able to implement the estimator and rain sensors or any other means allowing weather, temperature and geolocation information to be obtained. In this embodiment, the vehicle 1 performs on board the method of FIG. 1 for determining the component μₑₓₜ extrinsic to the vehicle of the coefficient of friction associated with the road segment 2, implementation of this method being represented in FIG. 4 by box 401. The vehicle 1 performs on board the prediction of the coefficient of friction μ of step 302 and then modifies its chassis parameters in step 303 depending on the prediction.

Thus, in the embodiment of FIG. 4, all of the methods of the invention are carried out by the same vehicle 1, on board and in real time during its first trip over the road segment 2. This first embodiment has the advantage of being autonomous, there being no need to communicate with the shared server. Nevertheless, the anticipation of the coefficient of friction μ is relatively short in nature, because it is limited by the performance of the camera, in particular its range.

FIG. 5 illustrates a second embodiment of the invention, in which vehicle 1 implements 401 the method for determining the component μₑₓₜ extrinsic to the vehicle of the coefficient of friction associated with the road segment 2 on its first trip over the road segment 2. The vehicle 1 then stores in a local map 3 that it has generated on board the averaged value of the determined extrinsic component. On its next trip when approaching the road segment 2, the vehicle 1 retrieves the value stored in the local map 3 for the current weather and temperature conditions, and makes the prediction of step 302. The vehicle 1 then configures its chassis parameters in step 303.

This second embodiment has the drawback, compared with the first embodiment, of not working on the first trip over the road segment 2, but requires a less powerful on-board computer. In addition, optimization of the chassis parameters may be carried out even when conditions do not allow the camera to capture images of sufficient quality to implement the determining method of FIG. 1, for example during thick fog, at night, or when the camera is obstructed.

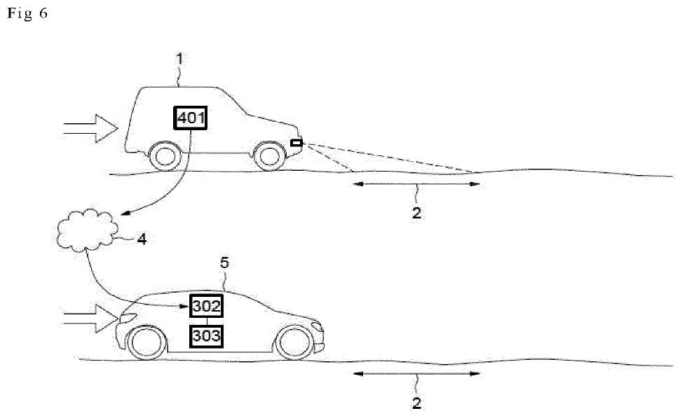

FIG. 6 illustrates a third embodiment of the invention, in which the vehicle 1 implements 401 the method for determining the component μₑₓₜ extrinsic to the vehicle of the coefficient of friction associated with the road segment 2 on its first trip toward the road segment 2. The vehicle 1 then sends to a shared map 4 the current weather and temperature conditions and the determined value of the extrinsic component, which is averaged in the shared map 4. Later, a second vehicle 5, which is not equipped with tools allowing the method for determining the extrinsic component μₑₓₜ of the coefficient of friction to be determined, is about to drive over the road segment 2. The vehicle 5 retrieves the value stored in the shared map 4 for the current weather and temperature conditions, and makes the prediction of step 302. The vehicle 5 then configures its chassis parameters in step 303. The vehicle 5 may likewise, using standard techniques for constructing an eHorizon, or electronic horizon, construct a local map including only the extrinsic components of its future route. The vehicle 5 therefore has access to the various values of extrinsic components of the coefficient of friction that it will need with a relatively long lead time. Indeed, the vehicle will have reconstructed on board only part of the shared map 4, this partial reconstruction being based on estimates of the possible route of the vehicle 5 obtained using a number of possible strategies. These strategies may be the destination programmed into the navigation system of the vehicle or the most probable path, or may be based on usual routes of the vehicle 5, or any other strategy for anticipating the route of a vehicle. By storing the information, for example in a cache system, the vehicle is able to obtain in advance all the extrinsic-component values that it will use during its journey.

This third embodiment has the advantage of allowing a large number of vehicles 1 to contribute to construction of a map, which will therefore be very accurate and robust. It is this large number of vehicles contributing to generation of the map that makes it possible to efficiently use statistical algorithms for constructing a confidence score. Another advantage is to allow vehicles 5 that do not have the tools—such as the camera oriented toward the front of the vehicle or the on-board estimator—required to carry out the method for determining the extrinsic component μₑₓₜ of the coefficient of friction to benefit from the map. Lower end-of-the-range connected vehicles may therefore optimize their chassis parameters.

In a last embodiment (not shown in a figure), a vehicle 1 is able to access the shared map. On its first trip over the road segment 2, it may retrieve from the shared map the value of the extrinsic component of the road segment 2 for the current meteorological conditions, then make the prediction 302 and carry out the optimization 303 in real time for its trip over the road segment 2. In parallel, it may carry out step 401 of implementing the method of FIG. 1 for determining the component extrinsic to the vehicle of the coefficient of friction associated with the road segment 2. In order to save resources, step 401 may be carried out once steps 302 and 303 have ended, without severe time constraints, the only condition being prior storage of the state data relating to the road segment 2. Once the method has ended, the new value of the component extrinsic to the vehicle of the coefficient of friction determined in step 401 may be shared by the vehicle with the shared map, and/or with a local map. Thus, the drawback of the second embodiment in which the first trip does not allow the chassis parameters to be optimized is avoided, all without the need for an on-board computer as powerful as the one required for the first embodiment. In addition, the shared map is updated.

1-18. (canceled)

19. A method for training an algorithm for automatically estimating a component extrinsic to a vehicle of a coefficient of friction of a road segment that matches, to state data relating to the road segment provided by way of input, an output value of the component extrinsic to the vehicle of the coefficient of friction of the road segment, the method comprising:
learning from a database of data on the state of road segments associated with values of components extrinsic to the vehicle of the coefficient of friction of these road segments, the collected data on the state of the road segments being collected by one or more vehicles equipped with a camera oriented toward a front of the vehicle.

20. The method as claimed in claim 19, wherein the data on the state of road segments comprise images of the road segment captured by a camera placed at the front of the vehicle and information on the weather and temperature at the time of capture of the image.

21. The method as claimed in claim 19, wherein the component extrinsic to the vehicle of the coefficient of friction associated with the data on the state of the road segments is deduced from the coefficient of friction associated with the road segments, the coefficient of friction being measured by the vehicle capturing the state data or being known prior to the collection of the state data by the vehicle.

22. A method for determining the component extrinsic to the vehicle of the coefficient of friction of a road segment located in front of a motor vehicle moving toward said road segment, the method comprising:
acquiring at least one state datum relating to the road segment; and
determining a value of the component extrinsic to the vehicle of the coefficient of friction of said road segment by an algorithm for automatically estimating the component extrinsic to the vehicle of the coefficient of friction of a road segment trained according to the method as claimed in claim 19.

23. The method as claimed in claim 22, wherein the at least one state datum relating to the road segment comprises one or more images of the road segment captured by a camera placed at the front of the vehicle.

24. The method as claimed in claim 22, wherein the at least one state datum of the road segment comprises one or more pieces of weather and temperature information.

25. The method as claimed in claim 22, further comprising, following the determining the value of the component extrinsic to the vehicle of the coefficient of friction, generating and updating a map of vehicle-road grip quality.

26. The method as claimed in claim 25, wherein the generating and updating the road grip-quality map comprises:
averaging the component extrinsic to the vehicle of the coefficient of friction calculated in the determining with values of components extrinsic to the vehicle of the coefficient of friction already stored in the map for the same road segment and similar weather and temperature data, and
storing the averaged value in association with the road segment and the current meteorological data.

27. The method as claimed in claim 26, wherein the storing is performed locally and/or on a shared server.

28. The method as claimed in claim 26, further comprising assigning a confidence score associated with the value stored in the map, the confidence score being calculated using a statistical algorithm.

29. A method for optimizing dynamic control of a chassis of a vehicle based on a component extrinsic to the vehicle of the coefficient of friction obtained using the method as claimed in claim 22, the method for optimizing dynamic control comprising:
retrieving a value of the component extrinsic to the vehicle of the coefficient of friction associated with a road segment in front of the vehicle,
determining a prediction of the value of the coefficient of friction associated with said road segment based on the retrieved component extrinsic to the vehicle of the coefficient of friction, and
configuring parameters of the chassis of the vehicle depending on the prediction.

30. The method for optimizing dynamic control as claimed in claim 29, wherein the value of the component extrinsic to the vehicle of the coefficient of friction retrieved in the retrieving is the value calculated in the determining the value of the component extrinsic to the vehicle of the coefficient of friction, the vehicle the chassis of which is modified being the same as the one that performed the determining the value of the component.

31. The method for optimizing dynamic control as claimed in claim 29, wherein the component extrinsic to the vehicle of the coefficient of friction is retrieved from the road grip-quality map depending on geolocation data and meteorological data.

32. The method for optimizing dynamic control as claimed in claim 29, wherein the prediction of the value of the coefficient of friction associated with the road segment is dependent on the retrieved value of the component extrinsic to the vehicle of the coefficient of friction and on a component intrinsic to the vehicle of the coefficient of friction, the intrinsic component being specific to the vehicle.

33. The method for optimizing dynamic control as claimed in claim 32, wherein the component intrinsic to the vehicle of the coefficient of friction is dependent on a wear factor of the chassis of the vehicle, and on a factor representative of a potential of the chassis of the new vehicle.

34. The method for optimizing dynamic control as claimed in claim 29, wherein the prediction of the value of the coefficient of friction associated with the road segment is determined on board the vehicle.

35. The method for optimizing dynamic control as claimed in claim 29, wherein the prediction of the value of the coefficient of friction associated with the road segment is determined in real time.

36. A motor vehicle configured to implement the method for optimizing dynamic control as claimed in claim 29.
